(19) United States
(12) Patent Application Publication
(10) Pub. No.: US 2025/0371347 A1
(43) Pub. Date: Dec. 4, 2025

(54) MODEL QUANTIZATION METHOD AND APPARATUS, AND DEVICE AND MEDIUM

(71) Applicant: TENCENT TECHNOLOGY (SHENZHEN) COMPANY LIMITED, Shenzhen (CN)

(72) Inventor: Yahui CHENG, Shenzhen (CN)

(21) Appl. No.: 19/300,416

(22) Filed: Aug. 14, 2025

Related U.S. Application Data
(63) Continuation of application No. PCT/CN2023/138326, filed on Dec. 13, 2023.

(30) Foreign Application Priority Data
Jun. 19, 2023 (CN) 202310733793.7

(51) Int. Cl. G06N 3/08

(52) U.S. Cl. CPC G06N 3/08

(57) ABSTRACT

This application discloses a model quantization method and apparatus, and a device and a medium. The method includes a model quantization method performed by a model quantization device, and the method comprising determining a first quantized network structure from a generative model, the first quantized network structure being a quantized structure of a partial network structure in the generative model, a target operator in the first quantized network structure corresponding to a plurality of pieces of input data having different data precisions; obtaining a second quantized network structure by inserting or deleting a fake-quantization node based on the first quantized network structure, data precisions of the plurality of pieces of input data of the target operator in the second quantized network structure being the same, and the fake-quantization node being a node for quantizing the input data; and training the generative model comprising the second quantized network structure.

### RELATED APPLICATIONS

This application is a continuation of PCT Application No. PCT/CN2023/138326, filed on Dec. 13, 2023, which claims priority to Chinese Patent Application No. 202310733793.7, filed on Jun. 19, 2023, and entitled “MODEL QUANTIZATION METHOD AND APPARATUS, AND DEVICE AND MEDIUM”, which are incorporated herein by reference in their entirety.

### FIELD OF THE TECHNOLOGY

This application relates to the field of artificial intelligence, and in particular to a model quantization method and apparatus, and a device and a medium.

### BACKGROUND OF THE DISCLOSURE

To improve the inference speed of an artificial intelligence model, related data in the artificial intelligence model needs to be quantized, which can implement quantization of data with float 16/32 precision into data with int 8 precision. A quantization operation is an operation for converting high-precision data into low-precision data. That is, in a quantization process, high-precision data that is the most time-consuming and/or the most resource-consuming is converted into low-precision data, thereby improving a data processing speed by losing data precision.

Often, after model quantization, hybrid precision calculation is performed on some operators. The hybrid precision calculation causes long calculation time of the operators and/or errors in the calculation result.

How to improve quantization solution for a generative model has become a technical problem that needs to be solved urgently.

### SUMMARY

This application provides a better quantization solution for a partial network structure of a generative model. The technical solution is as follows:

According to an aspect of this application, a model quantization method is provided, the method being performed by a model quantization device. The method includes a model quantization method performed by a model quantization device, and the method comprising determining a first quantized network structure from a generative model, the first quantized network structure being a quantized structure of a partial network structure in the generative model, a target operator in the first quantized network structure corresponding to a plurality of pieces of input data having different data precisions; obtaining a second quantized network structure by inserting or deleting a fake-quantization node based on the first quantized network structure, data precisions of the plurality of pieces of input data of the target operator in the second quantized network structure being the same, and the fake-quantization node being a node for quantizing the input data; and training the generative model comprising the second quantized network structure.

According to one aspect of this application, a computer device is provided, the computer device including: a processor and a memory, the memory having a computer program stored therein, and the computer program being loaded and executed by the processor to implement the above model quantization method.

According to another aspect of this application, a non-transitory computer-readable storage medium is provided, having a computer program stored therein, the computer program being loaded and executed by a processor to implement the above model quantization method.

In embodiments consistent with the present disclosure, a quantization result of a partial network structure in a generative model is obtained by training a second quantized network structure. The second quantized network structure is obtained by inserting or deleting a fake-quantization node based on a first quantized network structure, and the first quantized network structure is a quantized structure of the partial network structure provided in the related art. A target operator with a plurality of pieces of input data having different data precisions exists in the first quantized network structure. By inserting or deleting the fake-quantization node, it is conductive to obtaining the second quantized network structure in which data precisions of a plurality of pieces of input data of the target operator are the same. That is, this application improves the first quantized network structure provided in the related art, and provides a better quantization solution for the partial network structure of the generative model.

### BRIEF DESCRIPTION OF THE DRAWINGS

FIG. 1 is a schematic diagram according to an embodiment of this application.

FIG. 2 is a flowchart of a model quantization method according to an embodiment of this application.

FIG. 3 is a schematic diagram of a generation principle of a second quantized network structure according to an embodiment of this application.

FIG. 4 is a flowchart of a model quantization method according to another embodiment of this application.

FIG. 5 is a schematic diagram of a generation principle of a second quantized network structure according to another embodiment of this application.

FIG. 6 is a flowchart of a model quantization method according to another embodiment of this application.

FIG. 7 is a schematic diagram of a generation principle of a second quantized network structure according to another embodiment of this application.

FIG. 8 is a flowchart of a model quantization method according to another embodiment of this application.

FIG. 9 is a schematic thumbnail of a second quantized network structure according to an embodiment of this application.

FIG. 10 is a flowchart of a model quantization method according to another embodiment of this application.

FIG. 11 is a structural block diagram of a model quantization apparatus according to an embodiment of this application.

FIG. 12 is a structural block diagram of a computer device according to an embodiment of this application.

### DESCRIPTION OF EMBODIMENTS

First, the terms involved in embodiments of this application are introduced.

Artificial intelligence (AI): AI involves a theory, a method, a technology, and an application system that use a digital computer or a machine controlled by the digital computer to simulate, extend, and expand human intelligence, perceive an environment, obtain knowledge, and use the knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

Machine Learning (ML): It is a multi-field inter-discipline, and relates to a plurality of disciplines such as probability theory, statistics, approximation theory, convex analysis, and algorithm complexity theory. ML specializes in studying how a computer simulates or implements a human learning behavior to obtain new knowledge or skills, and reorganizes an existing knowledge structure, so as to keep improving its performance. ML is the core of AI, is a basic way to make the computer intelligent, and is applied to various fields of AI. The ML and the deep learning generally include technologies such as an artificial neural network, a confidence network, reinforcement learning, transfer learning, inductive learning, and learning from demonstration. With the research and progress of the AI technology, the AI technology has been studied and applied to a plurality of fields, for example, a common smart home, a smart wearable device, a virtual assistant, a smart speaker, smart marketing, unmanned driving, automatic driving, an unmanned aerial vehicle, a robot, smart medical care, and smart customer service.

Model quantization: Quantization means a process of mapping a value in a continuous set to a discrete set. In the field of machine learning, the mapping is usually from a float number to an integer value. For example, a float 32 value is quantized to an int 8 value. Dequantization is to inversely map a value in a discrete set into a continuous set. There is an information loss in a quantization process, but there is no information loss during dequantization. The reason is that float 32 may store a larger value range than int 8. During quantization, it is inevitable that a large quantity of values cannot be represented by int 8, and can only be rounded into values of int 8. An error of a quantized model comes from a rounding or clip operation.

Despite losing data precision, model quantization offers several advantages:

1. Fewer storage overheads and bandwidth requirements. Quantized data occupies fewer bits, thereby effectively reducing dependency of a neural network model on storage resources.

2. Lower power consumption. Compared with moving 32 bits of float data, moving 8 bits of int data has efficiency that is four times higher than that of moving 32 bits of float data. To certain extent, memory usage is in direct proportion to power consumption.

3. Higher calculation speed. Compared with a float number, most processors support processing of 8-bit int data, and binary quantization is more advantageous.

In a neural network model, a value mainly includes three parts: a neural network weight, an intermediate output feature map, and a gradient. If the neural network weight and the intermediate output feature map can be quantized, the entire neural network model can be run on hardware during reasoning. In addition, if the gradient may alternatively be fixed, a training process of the neural network model may be accelerated.

Fake-quantization node: A model quantization method may be classified into quantization after training and quantization during training (quantization perception training). The quantization perception training aims to train a neural network model in a quantization process, so that network parameters can better reduce an information loss caused by quantization. During the quantization perception training, a fake-quantization node (Fake-Quant op) is inserted into the neural network model. During the training, the fake-quantization node quantizes a value of float 32 to a value of int 8. Strictly, the fake-quantization node includes a quantization subnode (Quant op) and a dequantization subnode (Dequant op). The quantization subnode first quantizes a value of float 32 into int 8, and then the dequantization subnode dequantizes the value of int 8 into float 32. This has an advantage that the neural network parameters may perceive the information error caused by quantization. The fake-quantization node belongs to a mature technology in the art, and will not be further described in detail herein. For descriptions of fake-quantization, refer to https://zhuanlan.zhihu.com/p/138059904.

Generative model: An optimized generative model in this application is a VQFR (a model structure). The VQFR includes two parts: an encoder and a decoder. Refer to https://arxiv.org/abs/2205. 06803 for descriptions of VQFR. In the related art, there are the following two quantization solutions for the generative model: 1. Quantization is performed through a PTQ solution provided by TensorRT (a model inference acceleration tool). The main idea of PTQ is direct quantization without training, and the training is fully completed by an internal black box of TensorRT. In a service, the PTQ solution has an excessively high data precision loss after quantization. 2. Quantization is performed through a QAT solution provided by TensorRT. The QAT solution of TensorRT does not support voluntary design of a quantization rule and manual modification of a model structure. If quantization is performed through the QAT solution, long development time of an entire procedure, high code invasiveness, and high complexity will be caused. Based on this, this application specifically provides quantization solutions for two types of network structures of a generative model.

A batch matrix-matrix (bmm) operator: It is an operator configured for calculating a product between at least two matrices.

A matrix dimension quantity reshape operator: It is an operator configured for adjusting the quantity of rows, a quantity of columns, and a quantity of dimensions of a matrix.

A matrix dimension sequence permute operator: It is an operator configured for transposing dimensions of a matrix, so as to permute arrays.

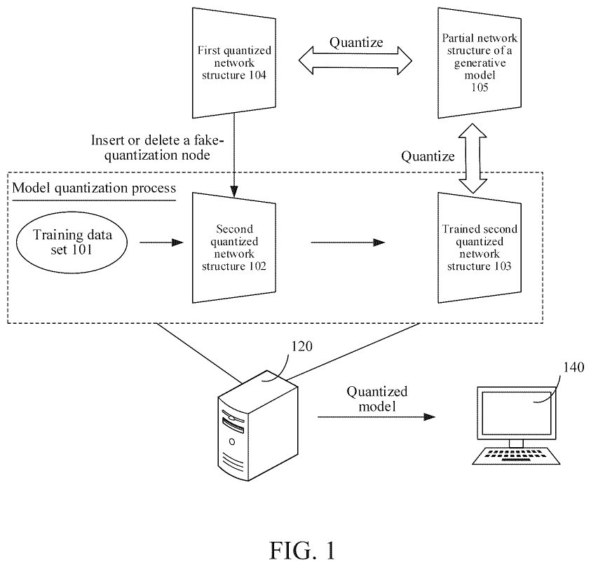

FIG. 1 is a structural block diagram of a computer system according to an embodiment of this application. The computer system includes a model quantization device 120 and a model operating device 140. The model quantization device 120 is configured to quantize a model and send the quantized model to the model operating device 140. The model operating device 140 uses a quantized model. The model quantization device 120 is connected to the model operating device 140 in a wired/wireless manner. In some embodiments, a model that needs to be quantized is a generative model. In some embodiments, the generative model is configured for generating data in modalities such as an image, text, an audio, and a video.

FIG. 1 shows a model quantization process according to an embodiment of this application. In the model quantization process, a training data set 101 is inputted to a second quantized network structure 102. During training, fine adjustment is performed on a network parameter (a neural network weight) of the second quantized network structure 102, to obtain a trained second quantized network structure 103. The second quantized network structure 102 is obtained by inserting or deleting a fake-quantization node into a first quantized network structure 104. The first quantized network structure 104 is obtained by performing quantization on a partial network structure 105 of a generative model. The trained second quantized network structure 103 is obtained through the model quantization process, and the trained second quantized network structure 103 is a quantization result of the partial network structure 105 of the generative model provided in this application.

The model quantization process provided in this application is a process of obtaining a final model quantization result by training the second quantized network structure 102 based on the second quantized network structure 102 obtained after the first quantized network structure 104 is improved. In some cases, in the first quantized network structure 104 of the generative model, some operators have long calculation time and do not perform data calculation under int 8 precision. Alternatively, in some cases, in the first quantized network structure 104 of the generative model, an operator calculates two pieces of input data as data of int 8 precision. As a result, the calculation result has a deviation and is erroneous. To resolve these problems, the second quantized network structure 102 provided in this application is obtained by inserting or deleting a fake-quantization node based on the first quantized network structure 104 and a principle that data precisions of a plurality of pieces of input data of the same target operator are the same. A specific insertion or deletion mode is described below with reference to a partial network structure of a generated network.

In one embodiment, the model quantization device 120 and the model operating device 140 may be different computer devices, or the model quantization device 120 and the model operating device 140 may be the same computer device. The computer device includes one or more servers, or the computer device includes one or more terminals, or the computer device includes both a terminal and a server. In some embodiments, the terminal is various types of terminals such as a mobile phone, a desktop computer, a notebook computer, a tablet computer, a smart television, a smart speaker, an in-vehicle terminal, an intelligent robot, or a smart watch. In some embodiments, the server may be a stand-alone physical server, may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In one embodiment, computer programs involved may be deployed on a computer device for execution, or may be executed on a plurality of computer devices at one location, or may be executed on a plurality of computer devices distributed at a plurality of locations and connected by a communication network. The plurality of computer devices distributed at the plurality of locations and connected by the communication network can form a blockchain system.

In one embodiment, the computer device is a node in the blockchain system. The node may store the trained second quantized network model in a blockchain, and then the node or a node corresponding to another device in the blockchain may obtain the trained second quantized network model from the blockchain.

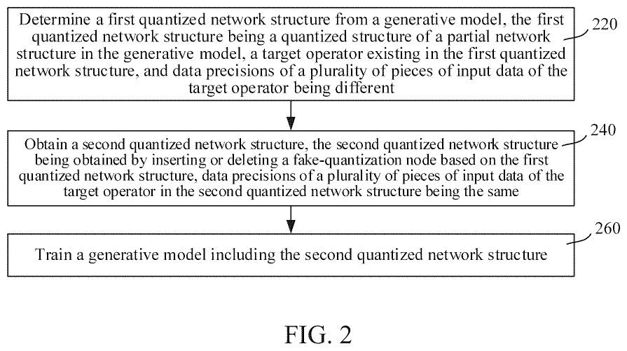

FIG. 2 shows a flowchart of a model quantization method according to an embodiment of this application. An example in which the method is performed by the model quantization device 120 shown in FIG. 1 is used for description. The method includes:

Operation 220: Determine a first quantized network structure from a generative model, the first quantized network structure being a quantized structure of a partial network structure in the generative model, a target operator existing in the first quantized network structure, and data precisions of a plurality of pieces of input data of the target operator being different.

The target operator exists in the generative model, and the data precisions of the plurality of pieces of input data of the target operator are different. During quantization on the target operator, often the calculation time of the target operator is long and/or a calculation result is erroneous due to hybrid precision calculation. In this application, the first quantized network structure including the target operator is adjusted, so that data precisions of a plurality of pieces of input data of the target operator in the obtained second quantized network structure are the same.

An operator is a calculation unit in the generative model. The target operator is an operator that corresponds to a plurality of pieces of input data having different data precisions in the generative model. In some embodiments, the target operator includes, but is not limited to, at least one of an addition operator, a multiplying operator, a bmm operator, and a matrix transpose operator. This embodiment of this application does not make a specific limitation on this.

Here, that the data precisions of the plurality of pieces of input data being different means that the data precisions of at least two of the plurality of pieces of input data are different, and the data precisions of some of the input data may be allowed to be the same. For example, there are five pieces of input data, among which, the data precisions of two pieces of input data are int 8 precision, and the data precisions of the remaining three pieces of input data are float 16/32 precision.

Operation 240: Obtain a second quantized network structure, the second quantized network structure being obtained by inserting or deleting a fake-quantization node based on the first quantized network structure, data precisions of the plurality of pieces of input data of the target operator in the second quantized network structure being the same.

This application provides a quantization method for a partial network structure in a generative model. The first quantized network structure is a quantized structure of the partial network structure.

A fake-quantization node is often referred to as Fake op (fake node), Fake Quant (fake-quantization), Fake-Quant op (fake-quantization node), quant dequant (QDQ, quantization-dequantization), and the like. The fake-quantization node is a node for quantizing input data, for example, quantizing data from a first precision to a second precision, for example, quantizing float 16/32 data into int 8 data. Actually, the fake-quantization node includes at least one of a quantization sub-node and a dequantization sub-node. For example, the quantization sub-node quantizes float 16/32 data into int 8 data, and the dequantization sub-node dequantizes int 8 data into float 16/32 data. However, only the quantization sub-node causes a loss in data precision. An effect of the fake-quantization node is that a quantization loss may be used in a model training process. In the training process, a model parameter may be finely adjusted to reduce the loss in data precision caused by the quantization.

In one embodiment, the second quantized network structure is obtained based on the first quantized network structure by inserting or deleting a fake-quantization node based on a principle that data precisions of a plurality of pieces of input data of the same target operator are the same. After the fake-quantization node is inserted or deleted, the plurality of pieces of input data of the same target operator all have int 8 precisions, all have float 16 precisions, or all have float 32 precisions.

In some embodiments, the first quantized network structure includes at least one of a quantized network branch and a network branch, and an operator. The obtaining a second quantized network structure includes at least one of the following operations, but not limited to:
obtaining the second quantized network structure by inserting the fake-quantization node into an output end of the network branch and an output end of the operator based on the first quantized network structure; obtaining the second quantized network structure by inserting the fake-quantization node into an output end of the quantized network branch based on the first quantized network structure; and obtaining the second quantized network structure by deleting the fake-quantization node from the quantized network branch based on the first quantized network structure.

Operation 260: Train the generative model including the second quantized network structure.

A training data set is obtained. The training data set is inputted to the second quantized network structure, to obtain output data of the training data set. The second quantized network is finely adjusted according to an error between the output data and a label. In this embodiment, the label may be considered as data outputted by the training data set via an unquantized partial network structure. The second quantized network structure after fine adjustment is determined as a finally obtained quantized structure of the partial network structure. In some embodiments, the second quantized network structure after fine adjustment is stored.

In conclusion, a quantization result of the partial network structure in the generative model is obtained by training the second quantized network structure. The second quantized network structure is obtained by inserting or deleting the fake-quantization node based on the first quantized network structure, and the first quantized network structure is a quantized structure of the partial network structure. It is beneficial for keeping the data precisions in a model consistent by inserting or deleting a fake-quantization node. That is, this application improves the first quantized network structure, and provides a better quantization solution for the partial network structure of the generative model.

In addition, the second quantized network structure is obtained based on the first quantized network structure by inserting or deleting the fake-quantization node based on the principle that the data precisions of the plurality of pieces of input data of the same target operator are the same. This avoids hybrid precision calculation that easily causes a calculation error and device damage.

Three types of second quantized network structures will be described below.

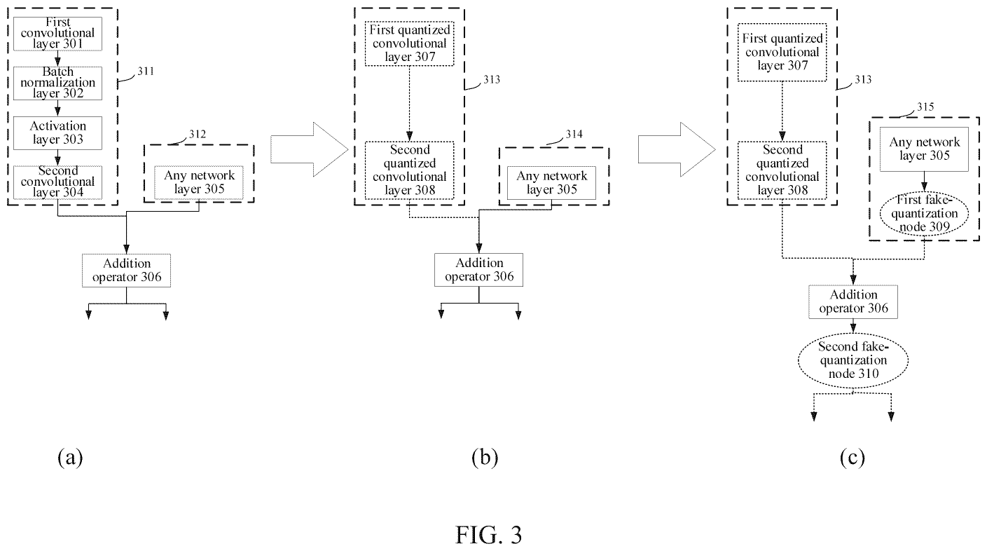

FIG. 3 is a schematic diagram of a structure generation principle of a first type of second quantized network structure. The dashed-line box in FIG. 3 indicates a quantized structure, and the dashed lines indicate that transmitted intermediate feature data has been quantized.

FIG. 3(a) shows a partial network structure in a generative model. The generative model includes two parts: an encoder and a decoder. FIG. 3(a) shows partial network structures in the encoder and the decoder. The partial network structure includes a first network branch 311, a second network branch 312, and an addition (Add) operator 306. The first network branch 311 includes a first convolutional (Conv) layer 301, a batch normalization (BN) layer 302, an activation (Relu) layer 303, and a second convolutional (Conv) layer 304 that have a cascading relationship. The second network branch 312 includes a network layer 305. An output of the first network branch 311 and an output of the second network branch 312 are used as inputs of the addition operator 306.

FIG. 3(b) shows a quantized structure of the foregoing partial network structure provided in the related art. FIG. 3(b) shows a first quantized network structure. FIG. 3(b) shows a first quantized network branch 313, a second network branch 314, and an addition operator 306. The first quantized network branch 313 includes a first convolutional layer, a batch normalization layer, an activation layer, and a second convolutional layer that are quantized and have a cascading relationship. An output of the first quantized network branch 313 and an output of the second network branch 314 are used as inputs of the addition operator 306.

In one embodiment, the first quantized network branch 313 includes a first quantized convolutional layer 307 and a second quantized convolutional layer 308 that have a cascading relationship. In one embodiment, the first quantized convolutional layer 307 is obtained by performing combined quantization on the first convolutional layer 301, the batch normalization layer 302, and the activation layer 303. Specifically, the first quantized convolutional layer 307 is obtained by quantizing an input and weight of a combined structure of the first convolutional layer 301, the batch normalization layer 302, and the activation layer 303. In one embodiment, the second quantized convolutional layer 308 is obtained after quantizing the second convolutional layer. Specifically, the second quantized convolutional layer 308 is obtained after quantizing an input and weight of the second convolutional layer.

In one embodiment, the first quantized convolutional layer 307 is obtained by inserting a fake-quantization node in front of the first convolutional layer 301 based on the first convolutional layer 301, the batch normalization layer 302, and the activation layer 303 that have the cascading relationship. The second quantized convolutional layer 308 is obtained by inserting a fake-quantization node in front of the second convolutional layer 304 based on the second convolutional layer 304. Each fake-quantization node in the first quantized network branch is configured for quantizing data with first precision into data with second precision, for example, quantizing data with float 16 precision into data with int 8 precision, or quantizing data with float 32 precision into data with int 8 precision.

FIG. 3(c) shows a second quantized network structure according to an embodiment of this application. The second quantized network structure includes a first quantized network branch 313, a second quantized network branch 315, an addition operator 306, and a second fake-quantization node 310. An output of the first quantized network branch 313 and an output of the second quantized network branch 315 are used as inputs of the addition operator 306. The first quantized network branch 313 includes a first convolutional layer, a batch normalization layer, an activation layer, and a second convolutional layer that are quantized and have a cascading relationship.

In one embodiment, the first quantized network branch 313 includes a first quantized convolutional layer 307 and a second quantized convolutional layer 308 that have a cascading relationship. The second quantized network branch 315 includes a network layer 305 and a first fake-quantization node 309 that are cascaded. An output of the second quantized convolutional layer 308 and an output of the first fake-quantization node 309 are used as inputs of the addition operator 306, and an output of the addition operator 306 is used as an input of the second fake-quantization node 310. The first fake-quantization node 309 and the second fake-quantization node 310 are both configured for quantizing data with first precision into data with second precision, for example, quantizing data with float 16 precision into data with int 8 precision, or quantizing data with float 32 precision into data with int 8 precision.

The quantized network structure shown in FIG. 3(c) is obtained by inserting a fake-quantization node into another network branch of the addition operator 306 and inserting a fake-quantization node behind the addition operator 306 based on the quantized network structure shown in FIG. 3(b). The quantized network structure shown in FIG. 3(c) may cause input data and output data of the addition operator 306 to both have the int 8 precision, thereby accelerating calculation.

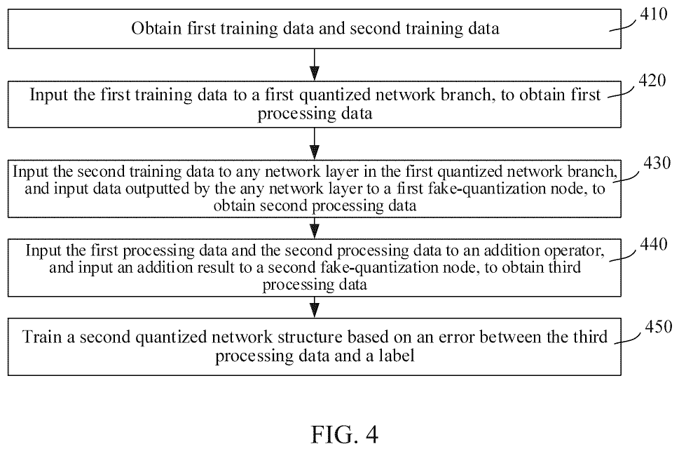

Based on the second quantized network structure shown in FIG. 3(c), FIG. 4 shows a model quantization method according to an embodiment of this application. The method is performed by a model quantization device. The method includes:

Operation 410: Obtain first training data and second training data.

The first training data and the second training data are data for performing model training.

The first training data is data obtained by performing feature extraction on any one of an image, text, an audio, and a video. The second training data is data obtained by performing feature extraction on any one of an image, text, an audio, and a video.

In some embodiments, the first training data is a feature vector obtained by extracting an image, and the second training data is a feature vector obtained by extracting an image. In some embodiments, the first training data is a feature vector obtained by extracting text, and the second training data is a feature vector obtained by extracting text. The first training data is a feature vector obtained by performing feature extraction on any one of an image, text, an audio, and a video. The second training data is a feature vector obtained by performing feature extraction on any one of an image, text, an audio, and a video.

Here, the first training data and the second training data may be feature vectors of the same type, or may not be feature vectors of the same type. For example, the first training data is an image feature vector, and the second training data is an image feature vector. Alternatively, the first training data is an image feature vector, and the second training data is a text feature vector.

Operation 420: Input the first training data to the first quantized network branch, to obtain first processing data.

In one embodiment, the first training data is inputted to the first quantized convolutional layer and the second quantized convolutional layer that are cascaded, to obtain first processing data. In some embodiments, first training data with float 16 precision is inputted to the first quantized convolutional layer and the second quantized convolutional layer that are cascaded, to obtain first processing data with int 8 precision. In some embodiments, first training data with float 32 precision is inputted to the first quantized convolutional layer and the second quantized convolutional layer that are cascaded, to obtain first processing data with int 8 precision.

Here, the first quantized network branch not only needs to quantize the first training data that is inputted, but also needs to quantize output data, to obtain the first processing data. The first quantized network branch further needs to quantize a model parameter during calculation. For example, when a convolution operation is performed, a convolution kernel further needs to be quantized through a fake-quantization node.

Operation 430: Input the second training data to the a network layer in the second network branch, and input data outputted by the a network layer to the first fake-quantization node, to obtain second processing data.

Second training data with float 16/32 precision is inputted to the a network layer in the second network branch, and data outputted by the a network layer in the second network branch is inputted to the first fake-quantization node, to obtain second processing data with int 8 precision.

The a network layer is any type of network layer.

Operation 440: Input the first processing data and the second processing data to the addition operator, and input an addition result to the second fake-quantization node, to obtain third processing data.

First processing data and second processing data that both have the same int 8 precision are inputted to the addition operator, and an addition result is inputted to the second fake-quantization node, to obtain third processing data with int 8 precision.

Operation 450: Train the second quantized network structure based on an error between the third processing data and a label.

In this embodiment, the label is data obtained by inputting the first training data and the second training data to an unquantized partial network structure. A loss function value is calculated according to a difference between the third processing data and the label. A model parameter of the generative model is updated according to the loss function value, to reduce an information loss caused by the quantization.

In conclusion, the second quantized network structure shown in FIG. 3(c) can be obtained after improving the first quantized network structure shown in FIG. 3(b) in this application. Compared with the first quantized network structure, the second quantized network structure can enable the input data and output data of the addition operator to both have the int 8 precision, thereby accelerating calculation.

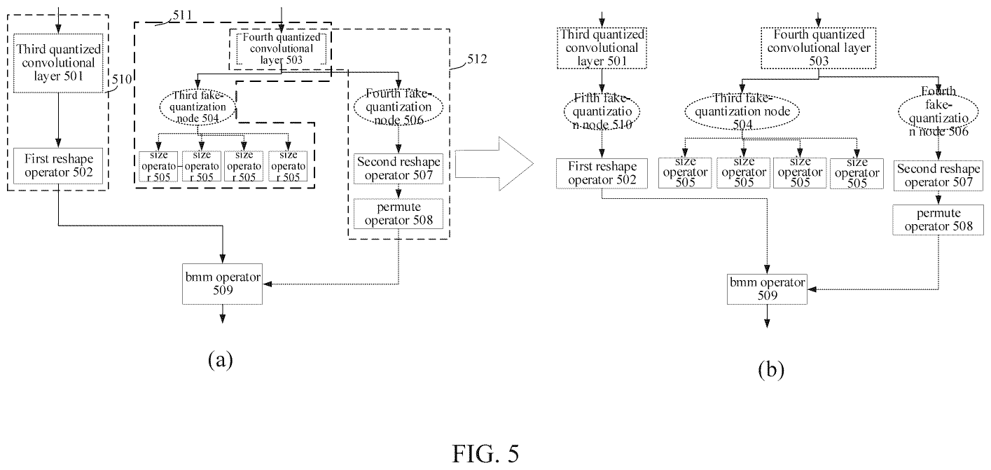

FIG. 5 is a schematic diagram of a structure generation principle of a second type of second quantized network structure. The dashed-line box in FIG. 5 indicates a quantized structure, and the dashed lines indicate that transmitted intermediate feature data has been quantized.

A first quantized network structure and a second quantized network structure in FIG. 5 are both quantized structures of an attention structure in a generative model. The attention structure includes a convolution operator, a matrix dimension quantity reshape operator (which is an operator for adjusting a row quantity, a column quantity, and a dimension quantity of a matrix), a matrix dimension sequence permute operator (which is an operator for rearranging arrays according to a specified vector), a bmm operator (a matrix multiplying operator), and the like.

FIG. 5(a) shows a quantized structure of a partial network structure of a generative model provided in the related art. FIG. 5(a) shows another first quantized network structure. The first quantized network structure includes a third quantized network branch 510, a fourth quantized network branch 511, a fifth quantized network branch 512, and a bmm operator 509. An output of the third quantized network branch 510 and an output of the fifth quantized network branch 512 are used as inputs of the bmm operator 509. The third quantized network branch 510 includes a third quantized convolutional layer 501 and a first reshape operator 502 that have a cascading relationship. The fourth quantized network branch 511 includes a fourth quantized convolutional layer 503, a third fake-quantization node 504, and a plurality of size operators 505 (which are operators for obtaining a row quantity and a column quantity of a matrix) that have a cascading relationship. The fifth quantized network branch 512 includes the fourth quantized convolutional layer 503, a fourth fake-quantization node 506, a second reshape operator 507, and a permute operator 508 that have a cascading relationship. The third quantized convolutional layer 501 is obtained by quantizing an input and weight of the third convolutional layer. In some embodiments, the third quantized convolutional layer 501 is obtained by inserting a fake-quantization node in front of the third convolutional layer. The fourth quantized convolutional layer 503 is obtained by quantizing an input and weight of the fourth convolutional layer. In some embodiments, the fourth quantized convolutional layer 503 is obtained by inserting a fake-quantization node in front of the fourth convolutional layer. FIG. 5(b) shows a quantized structure obtained by improving the first quantized network structure provided in FIG. 5(a). In the improved quantized structure, the third quantized network branch 510 includes the third quantized convolutional layer 503, the fifth fake-quantization node 510, and the first reshape operator 502 that have a cascading relationship.

The quantized structure shown in FIG. 5(b) is obtained by adding a fifth fake-quantization node based on the quantized network structure provided in FIG. 5(a). In the quantized structure shown in FIG. 5(a), data outputted by the third fake-quantization node 504 and data outputted by the fourth fake-quantization node 506 have int 8 precision; data inputted by the fifth quantization branch to the bmm operator 509 has int 8 precision; and data outputted by the third quantized convolutional layer 501 is not quantized. During calculation, the bmm operator 509 incorrectly combines the two pieces of input data into int 8 precision for calculation, so that the calculation has a deviation, and a calculation result is incorrect. The fifth fake-quantization node 510 is added behind the third quantized convolutional layer 501, so that during calculation, the bmm operator 509 correctly combines the two pieces of data into int 8 precision for calculation, thereby solving a problem of an incorrect calculation result and achieving improved reasoning performance.

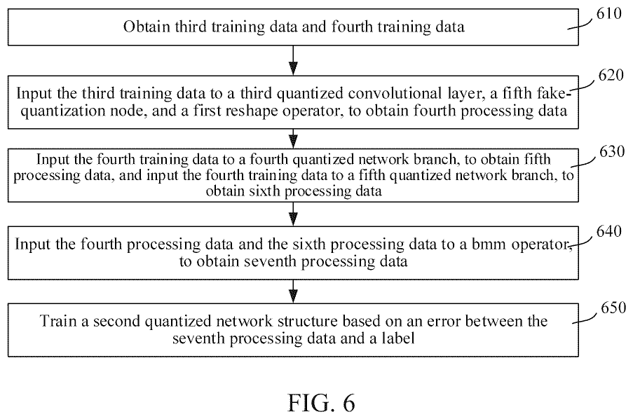

Based on the second quantized network structure shown in FIG. 5(b), FIG. 6 shows a model quantization method according to an embodiment of this application. The method is performed by a model quantization device.

Operation 610: Obtain third training data and fourth training data.

The third training data and the fourth training data are data for performing model training.

The third training data is data obtained by performing feature extraction on any one of an image, text, an audio, and a video. The fourth training data is data obtained by performing feature extraction on any one of an image, text, an audio, and a video.

In some embodiments, the third training data is a feature vector obtained by extracting an image, and the fourth training data is a feature vector obtained by extracting an image. In some embodiments, the third training data is a feature vector obtained by extracting text, and the fourth training data is a feature vector obtained by extracting text. The third training data is a feature vector obtained by performing feature extraction on any one of an image, text, an audio, and a video. The fourth training data is a feature vector obtained by performing feature extraction on any one of an image, text, an audio, and a video.

Here, the third training data and the fourth training data may be feature vectors of the same type, or may not be feature vectors of the same type. For example, the third training data is an image feature vector, and the fourth training data is an image feature vector. Alternatively, the third training data is an image feature vector, and the fourth training data is a text feature vector.

Operation 620: Input the third training data to the third quantized convolutional layer, the fifth fake-quantization node, and the first reshape operator, to obtain fourth processing data.

The third quantized convolutional layer is a quantized convolutional layer obtained by quantizing the third convolutional layer. In some embodiments, the third quantized convolutional layer is obtained by inserting a fake-quantization node in front of the third convolutional layer based on the third convolutional layer. After data with float 16/32 precision is inputted to the third quantized convolutional layer, data outputted by the third quantized convolutional layer is further inputted to the fifth fake-quantization node, to obtain data with int 8 precision. The data is inputted to the first reshape operator, to obtain fourth processing data with int 8 precision.

Operation 630: Input the fourth training data to the fourth quantized network branch, to obtain fifth processing data, and input the fourth training data to the fifth quantized network branch, to obtain sixth processing data.

The fourth quantized network branch includes a fourth quantized convolutional layer, a third fake-quantization node, and a plurality of size operators have a cascading relationship.

The fourth training data is inputted to the fourth quantized convolutional layer, the third fake-quantization node, and the plurality of size operators, to obtain the fifth processing data. The fourth training data is inputted to the fourth quantized convolutional layer, the fourth fake-quantization node, the second reshape operator, and the permute operator, to obtain the sixth processing data.

The fourth quantized convolutional layer is obtained by inserting a fake-quantization node in front of the fourth convolutional layer based on the fourth convolutional layer. After data with float 16/32 precision is inputted to the fourth quantized convolutional layer, data outputted by the fourth quantized convolutional layer is further inputted to the third fake-quantization node, to obtain data with int 8 precision. The data is respectively inputted to the plurality of size operators, to obtain fifth processing data with int 8 precision.

Moreover, the data outputted by the fourth quantized convolutional layer is further inputted to the fourth fake-quantization node, to obtain data with int 8 precision. The data is inputted to the second reshape operator and the permute operator, to obtain sixth processing data with int 8 precision.

Operation 640: Input the fourth processing data and the sixth processing data to the bmm operator, to obtain seventh processing data.

The fourth processing data with the int 8 precision and the sixth processing data with the int 8 precision are inputted to the bmm operator, to obtain seventh processing data with int 8 precision.

Operation 650: Train the second quantized network structure based on an error between the seventh processing data and a label.

In this embodiment, the label may be considered as data obtained by inputting the third training data and the fourth training data to an unquantized partial network structure. A loss function value is calculated according to a difference between the seventh processing data and the label. A model parameter of the generative model is updated according to the loss function value, to reduce an information loss caused by the quantization.

In conclusion, the second quantized network structure shown in FIG. 5(b) can be obtained after improving the first quantized network structure shown in FIG. 5(a). Compared with the first quantized network structure, the second quantized network structure may cause the two pieces of input data of the bmm operator to both have int 8 precision, thereby solving a problem of an incorrect calculation result of the bmm operator in the first quantized network structure and achieving improved reasoning performance.

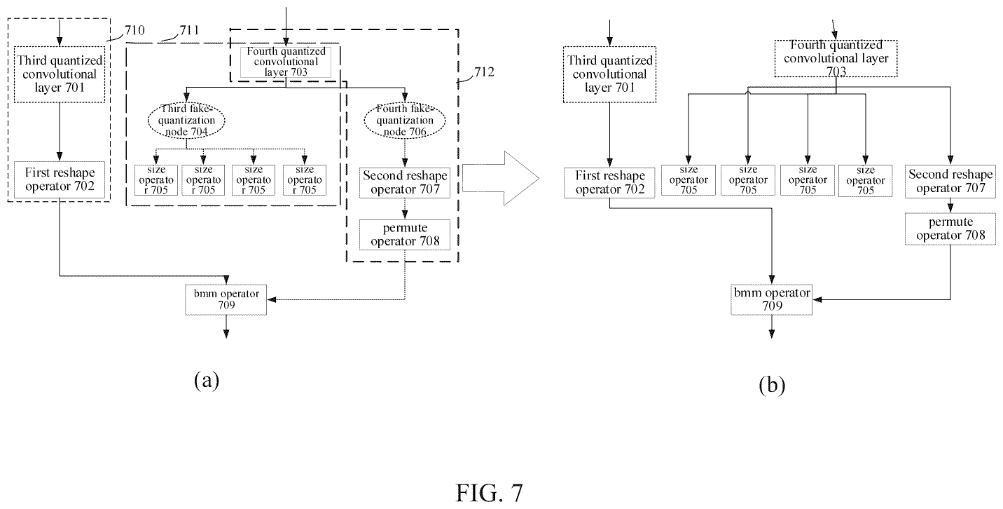

FIG. 7 is a schematic diagram of a structure generation principle of a third type of second quantized network structure. The dashed-line box in FIG. 7 indicates a quantized structure, and the dashed lines indicate that transmitted intermediate feature data has been quantized.

A first quantized network structure and a second quantized network structure in FIG. 7 are both quantized structures of an attention structure in a generative model.

FIG. 7(a) shows a quantized structure of a partial network structure of a generative model provided in the related art. FIG. 7(a) shows a first quantized network structure. The first quantized network structure includes a third quantized network branch 710, a fourth quantized network branch 711, a fifth quantized network branch 712, and a bmm operator 709. The third quantized network branch 710, the fourth quantized network branch 711, and the fifth quantized network branch 712 are connected in parallel. The fourth quantized network branch 711 and the fifth quantized network branch 712 have the same input. An output of the third quantized network branch 710 and an output of the fifth quantized network branch 712 are used as inputs of the bmm operator 709. The third quantized network branch 710 includes a third quantized convolutional layer 701 and a first reshape operator 702 that have a cascading relationship. An output of the third quantized convolutional layer 701 is connected to an input of the first reshape operator 702. The fourth quantized network branch 711 includes a fourth quantized convolutional layer 703, a third fake-quantization node 704, and a plurality of size operators 705 that have a cascading relationship. The fourth quantized convolutional layer 703 is connected to the plurality of size operators 705 through the third fake-quantization node 704. The fifth quantized network branch 712 includes the fourth quantized convolutional layer 703, a fourth fake-quantization node 706, a second reshape operator 707, and a permute operator 708 that have a cascading relationship. The fourth quantized convolutional layer 703 is connected to the second reshape operator 707 through the fourth fake-quantization node 706, and an output of the second reshape operator 707 is connected to an input of the permute operator 708. The third quantized convolutional layer 701 is obtained by quantizing an input and weight of the third convolutional layer. In some embodiments, the third quantized convolutional layer 701 is obtained by inserting a fake-quantization node in front of the third convolutional layer. The fourth quantized convolutional layer 703 is obtained by quantizing an input and weight of the fourth convolutional layer. In some embodiments, the fourth quantized convolutional layer 703 is obtained by inserting a fake-quantization node in front of the fourth convolutional layer.

FIG. 7(b) shows a quantized structure obtained by improving the first quantized network structure provided in FIG. 7(a). In the improved quantized structure, the fourth quantized network branch includes the fourth quantized convolutional layer 703 and the plurality of size operators 705 that have a cascading relationship. The fourth quantized convolutional layer 703 is directly connected to the plurality of size operators 705. The fifth quantized network branch includes the fourth quantized convolutional layer 703, the second reshape operator 707, and the permute operator 708 that have a cascading relationship. An output of the fourth quantized convolutional layer 703 is connected to an input of the second reshape operator 707, and an output of the second reshape operator 707 is connected to an input of the permute operator 708.

The quantized structure shown in FIG. 7(b) is obtained by deleting the third fake-quantization node 704 and the fourth fake-quantization node 706 based on the quantized network structure provided in FIG. 7(a). In the quantized structure shown in FIG. 7(a), data outputted by the third fake-quantization node 704 and data outputted by the fourth fake-quantization node 706 have int 8 precision; data inputted by the fifth quantization branch to the bmm operator 709 has int 8 precision; and data outputted by the third quantized convolutional layer 701 is not quantized. During calculation, the bmm operator 709 incorrectly combines the two pieces of input data into int 8 precision for calculation, so that the calculation has a deviation, and a calculation result is incorrect. By deleting the third fake-quantization node 704 and the fourth fake-quantization node 706, during calculation, the bmm operator 709 combines the two pieces of input data into float 16/32 precision for calculation, thereby solving the problem of an incorrect calculation result.

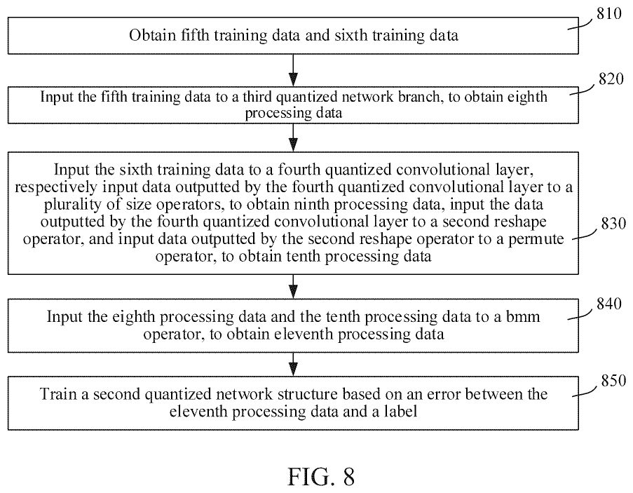

Based on the second quantized network structure shown in FIG. 7(b), FIG. 8 shows a model quantization method according to an embodiment of this application. The method is performed by a model quantization device.

Operation 810: Obtain fifth training data and sixth training data.

The fifth training data and the sixth training data are data for performing model training.

The fifth training data is data obtained by performing feature extraction on any one of an image, text, an audio, and a video. The sixth training data is data obtained by performing feature extraction on any one of an image, text, an audio, and a video.

In some embodiments, the fifth training data is a feature vector obtained by extracting an image, and the sixth training data is a feature vector obtained by extracting an image. In some embodiments, the fifth training data is a feature vector obtained by extracting text, and the sixth training data is a feature vector obtained by extracting text. The fifth training data is a feature vector obtained by performing feature extraction on any one of an image, text, an audio, and a video. The sixth training data is a feature vector obtained by performing feature extraction on any one of an image, text, an audio, and a video.

Here, the fifth training data and the sixth training data may be feature vectors of the same type, or may not be feature vectors of the same type. For example, the fifth training data is an image feature vector, and the sixth training data is an image feature vector. Alternatively, the fifth training data is an image feature vector, and the sixth training data is a text feature vector.

Operation 820: Input the fifth training data to the third quantized network branch, to obtain eighth processing data.

The third quantized network branch includes a third quantized convolutional layer and a first reshape operator that have a cascading relationship. An output of the third quantized convolutional layer is connected to an input of the first reshape operator.

The fifth training data is inputted to the third quantized convolutional layer and the first reshape operator, to obtain the eighth processing data. The third quantized convolutional layer is a quantized convolutional layer obtained by quantizing the third convolutional layer. In some embodiments, the third quantized convolutional layer is obtained by inserting a fake-quantization node in front of the third convolutional layer based on the third convolutional layer.

In one embodiment, after the data with float 16/32 precision is inputted to the third quantized convolutional layer, data outputted by the third quantized convolutional layer is further inputted to the first reshape operator, to obtain eighth processing data with float 16/32 precision.

Operation 830: Input the sixth training data to the fourth quantized convolutional layer, and respectively input data outputted by the fourth quantized convolutional layer to the plurality of size operators, to obtain ninth processing data, and input the data outputted by the fourth quantized convolutional layer to the second reshape operator, and input data outputted by the second reshape operator to the permute operator, to obtain tenth processing data.

In one embodiment, sixth training data with float 16/32 precision is inputted to the fourth quantized convolutional layer, and data outputted by the fourth quantized convolutional layer is respectively inputted to the plurality of size operators, to obtain ninth processing data with float 16/32 precision. The data outputted by the fourth quantized convolutional layer is inputted to the second reshape operator, and data outputted by the second reshape operator is inputted to the permute operator, to obtain tenth processing data with float 16/32 precision.

Operation 840: Input the eighth processing data and the tenth processing data to the bmm operator, to obtain eleventh processing data.

In one embodiment, eighth processing data with float 16/32 precision and tenth processing data with float 16/32 precision are inputted to the bmm operator, to obtain eleventh processing data with float 16/32 precision.

Operation 850: Train the second quantized network structure based on an error between the eleventh processing data and a label.

In this embodiment, the label may be considered as data obtained by inputting the fifth training data and the sixth training data to an unquantized partial network structure. A loss function value is determined according to a difference between the eleventh processing data and the label. A model parameter of the generative model is updated according to the loss function value, to reduce an information loss caused by the quantization.

In conclusion, the second quantized network structure shown in FIG. 7(b) can be obtained after improving the first quantized network structure shown in FIG. 7(a). Compared with the first quantized network structure, the second quantized network structure may cause the two pieces of input data of the bmm operator to both have float 16/32 precision, thereby solving a problem of an incorrect calculation result of the bmm operator in the first quantized network structure.

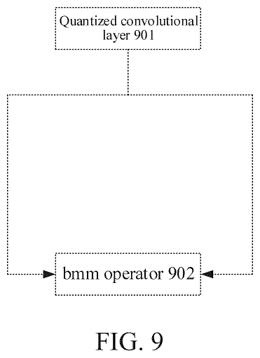

Based on the second quantized network structures shown in FIG. 5 and FIG. 7, FIG. 9 shows a schematic diagram of a simple representation of a second quantized network structure. The dashed-line box in FIG. 9 indicates a quantized structure, and the dashed lines indicate that transmitted intermediate feature data has been quantized. The second quantized network structure is represented as a quantized convolutional layer 901 and a bmm operator 902.

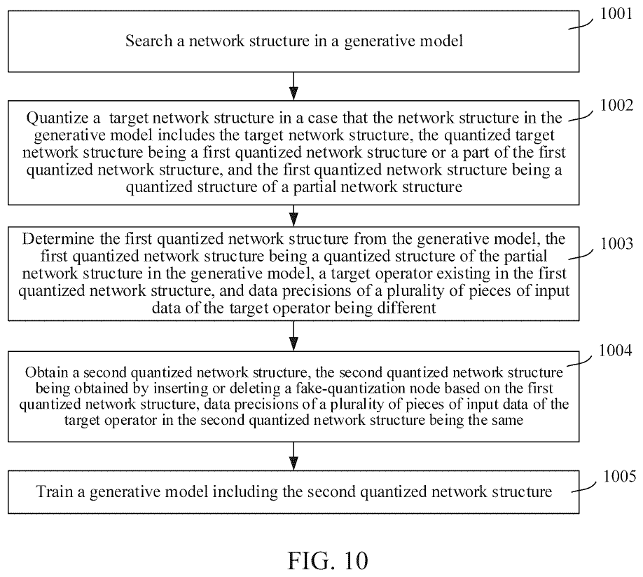

FIG. 10 shows a flowchart of a model quantization method according to an embodiment of this application. An example in which the method is performed by the model quantization device 120 shown in FIG. 1 is used for description. The method includes:

Operation 1001: Search a network structure in a generative model.

The generative model is obtained, and the network structure of the generative model is searched for a target network structure.

In some embodiments, referring to FIG. 3(a), the target network structure includes a combined structure of a first convolutional layer 301, a batch normalization layer 302, and an activation layer 303, and a second convolutional layer 304. An output of the first convolutional layer 301 is connected to an input of the batch normalization layer 302; an output of the batch normalization layer 302 is connected to an input of the activation layer 303; and an output of the activation layer 303 is connected to an input of the second convolutional layer 304.

In some embodiments, with reference to FIG. 5(a), the target network structure includes a third convolutional layer corresponding to a third quantized convolutional layer 501 having only one output branch, and a fourth convolutional layer corresponding to a fourth quantized convolutional layer 503 having two output branches. The third convolutional layer and the fourth convolutional layer are connected in parallel.

In some embodiments, with reference to FIG. 7(a), the target network structure includes a third convolutional layer corresponding to a third quantized convolutional layer 701 having only one output branch, and a fourth convolutional layer corresponding to a fourth quantized convolutional layer 703 having two output branches. The third convolutional layer and the fourth convolutional layer are connected in parallel.

Operation 1002: Quantize a target network structure in a case that the network structure in the generative model includes the target network structure, the quantized target network structure being a first quantized network structure or a part of the first quantized network structure, and the first quantized network structure being a quantized structure of a partial network structure.

In some embodiments, with reference to FIG. 3(a), a first quantized convolutional layer 307 is obtained by quantizing the combined structure of the first convolutional layer 301, the batch normalization layer 302, and the activation layer 303. A second quantized convolutional layer 308 is obtained by quantizing the second convolutional layer 304. Specifically, the first quantized convolutional layer 307 is obtained by quantizing an input and weight of the combined structure of the first convolutional layer 301, the batch normalization layer 302, and the activation layer 303. The second quantized convolutional layer 308 is obtained by quantizing an input and weight of the second convolutional layer 304. To be specific, the first quantized convolutional layer 307 and the second quantized convolutional layer 308 are obtained by quantizing the target network structure. In this case, the quantized target network structure is a part of the first quantized network structure.

In some embodiments, with reference to FIG. 5(b), a third quantized convolutional layer 501 is obtained by quantizing the third convolutional layer having only one output branch. A fourth quantized convolutional layer 503, a third fake-quantization node 504, and a fourth fake-quantization node 506 are obtained by quantizing the fourth convolutional layer having the two output branches. Specifically, the third quantized convolutional layer 501 is obtained by quantizing an input and weight of the third convolutional layer having only one output branch. The fourth quantized convolutional layer 503 is obtained by quantizing an input and weight of the fourth convolutional layer having the two output branches, and the third fake-quantization node 504 and the fourth fake-quantization node 506 are obtained by quantizing the two output branches. To be specific, the third quantized convolutional layer 501, the fourth quantized convolutional layer 503, the third fake-quantization node 504, and the fourth fake-quantization node 506 are obtained by quantizing the target network structure. In this case, the quantized target network structure is a part of the first quantized network structure.

In some embodiments, with reference to FIG. 7(b), a third quantized convolutional layer 701 is obtained by quantizing the third convolutional layer having only one output branch. A fourth quantized convolutional layer 703, a third fake-quantization node 704, and a fourth fake-quantization node 706 are obtained by quantizing the fourth convolutional layer having the two output branches. Specifically, the third quantized convolutional layer 701 is obtained by quantizing an input and weight of the third convolutional layer having only one output branch. The fourth quantized convolutional layer 703 is obtained by quantizing an input and weight of the fourth convolutional layer having the two output branches, and the third fake-quantization node 704 and the fourth fake-quantization node 706 are obtained by quantizing the two output branches. To be specific, the third quantized convolutional layer 701, the fourth quantized convolutional layer 703, the third fake-quantization node 704, and the fourth fake-quantization node 706 are obtained by quantizing the target network structure. In this case, the quantized target network structure is a part of the first quantized network structure.

Operation 1003: Determine the first quantized network structure from the generative model, the first quantized network structure being a quantized structure of the partial network structure in the generative model, a target operator existing in the first quantized network structure, and data precisions of a plurality of pieces of input data of the target operator being different.

Operation 1004: Obtain a second quantized network structure, the second quantized network structure being obtained by inserting or deleting a fake-quantization node based on the first quantized network structure, data precisions of a plurality of pieces of input data of the target operator in the second quantized network structure being the same.

Operation 1005: Train the generative model including the second quantized network structure.

In one embodiment, the model quantization method provided by this application may be integrated into a Tiacc-quant tool (Tiacc is an acceleration tool for model training provided in the related art, and Tiacc-quant is a tool related to quantization in Tiacc). Therefore, the model quantization method provided by this application includes the following operations:

(1) A user provides a model definition file and a model parameter of a model that has the highest precision in a current task.

(2) Quantization is performed by using the Tiacc-quant tool. Specific operations may be represented as the following codes.

```
  # load pretrain model
  model = load_ckpt (‘/the/path/to/best/ckpt’)
  #quantize the model through the Tiacc-quant tool
  model = prepare_model (model) # including a quantization rule in the related art
and an optimization rule of this application
  #finely adjust a quantized model in a training process
  for epoch in total_epochs
  prepare_training(model)
  #save the model on which quantization perception training has been performed as
js
  model = prepare_jit(model)
  jit_model = torch.jit.trace(model, inputs)
  torch.jit.save(jit_model, saved_path)
```

(3) A model implements real acceleration by using Tiacc-inference (Tiacc-inference is a tool related to reasoning in Tiacc), and an acceleration ratio is tested.

Detailed descriptions will be made below with reference to three types of generative models.

First type of possible generative model: A partial network structure of the generative model is configured for processing image feature data to obtain processed quantized feature data.

In one embodiment, in a case that the image feature data is processed and a second quantized network structure is the first type of second quantized network structure shown in FIG. 3, a first image quantized network structure corresponds to the first quantized network structure in FIG. 3, and a second image quantized network structure corresponds to the second quantized network structure in FIG. 3. The second image quantized network structure is obtained. The second image quantized network structure is obtained by inserting or deleting a fake-quantization node based on the first image quantized network structure, and the first image quantized network structure is a quantized structure of the partial network structure in the generative model. The second image quantized network structure is trained. The trained second image quantized network structure is determined as a quantization result of the partial network structure.

In some embodiments, the second image quantized network structure is obtained based on the first image quantized network structure by inserting or deleting a fake-quantization node based on a principle that data precisions of a plurality of pieces of input data of the same target operator are the same.

In one embodiment, in the case that the image feature data is processed, the first image quantized network branch corresponds to the first quantized network branch 313 in FIG. 3. As shown in FIG. 3(b), the first image quantized network structure includes a first image quantized network branch, a second network branch 312, and an addition operator 306. The first image quantized network branch includes a first convolutional layer 301, a batch normalization layer 302, an activation layer 303, and a second convolutional layer 304 that are quantized and that have a cascading relationship. The second network branch 312 includes a network layer 305. An output of the first image quantized network branch and an output of the second network branch 312 are used as inputs of the addition operator 306. The second image quantized network structure is obtained by inserting a first fake-quantization node 309 into an output end of the second network branch 312 and inserting a second fake-quantization node 310 into an output end of the addition operator 306 based on the first image quantized network structure.

First image training data and second image training data are obtained. The first image training data and the second image training data are intermediate feature data obtained based on an image. The first image training data is inputted to the first image quantized network branch, to obtain first processing data. The second image training data is inputted to the a network layer 305, and data outputted by a network layer 305 is inputted to the first fake-quantization node 309, to obtain second processing data. The first processing data and the second processing data are inputted to the addition operator 306, and an addition result is inputted to the second fake-quantization node 310, to obtain third processing data. The second image quantized network structure is trained based on an error between the third processing data and a label.

In some embodiments, the first image quantized network branch includes a first quantized convolutional layer 307 and a second quantized convolutional layer 308. The first quantized convolutional layer 307 is obtained by combined quantization based on the first convolutional layer 301, the batch normalization layer 302, and the activation layer 303. The second quantized convolutional layer 308 is obtained by quantizing the second convolutional layer 304.

In one embodiment, in a case that the image feature data is processed and a second quantized network structure is the second type of second quantized network structure shown in FIG. 5, a first image quantized network structure corresponds to the first quantized network structure in FIG. 5; a second image quantized network structure corresponds to the second quantized network structure in FIG. 5; a third image quantized network branch corresponds to the third quantized network branch 510 in FIG. 5; a fourth image quantized network branch corresponds to the fourth quantized network branch 511 in FIG. 5; and a fifth image quantized network branch corresponds to the fifth quantized network branch 512 in FIG. 5. As shown in FIG. 5(a), the first image quantized network structure includes a third image quantized network branch, a fourth image quantized network branch, a fifth image quantized network branch, and a bmm operator 509. An output of the third image quantized network branch and an output of the fifth image quantized network branch are used as inputs of the bmm operator 509. The third image quantized network branch includes a third quantized convolutional layer 501 and a first matrix dimension quantity reshape operator 502 that have a cascading relationship. The fourth image quantized network branch includes a fourth quantized convolutional layer 503, a third fake-quantization node 504, and a plurality of size operators 505 that have a cascading relationship. The fifth image quantized network branch includes the fourth quantized convolutional layer 503, a fourth fake-quantization node 506, a second reshape operator 507, and a matrix dimension sequence permute operator 508 that have a cascading relationship. The second image quantized network structure is obtained by inserting a fifth fake-quantization node 510 into an output end of the third quantized convolutional layer 501 based on the first image quantized network structure, as shown in FIG. 5(b).

Third image training data and fourth image training data are obtained. The third image training data and the fourth image training data are intermediate feature data obtained based on an image. The third image training data is inputted to the third quantized convolutional layer 501, the fifth fake-quantization node 510, and the first reshape operator 502, to obtain fourth processing data. The fourth image training data is inputted to the fourth image quantized network branch, to obtain fifth processing data. The fourth training data is inputted to the fifth image quantized network branch, to obtain sixth processing data. The fourth processing data and the sixth processing data are inputted to the bmm operator 509, to obtain seventh processing data. The second image quantized network structure is trained based on an error between the seventh processing data and a label.

In one embodiment, in a case that the image feature data is processed and a second quantized network structure is the third type of second quantized network structure shown in FIG. 7, a first image quantized network structure corresponds to the first quantized network structure in FIG. 7; a second image quantized network structure corresponds to the second quantized network structure in FIG. 7; a third image quantized network branch corresponds to the third quantized network branch 710 in FIG. 7; a fourth image quantized network branch corresponds to the fourth quantized network branch 711 in FIG. 7; and a fifth image quantized network branch corresponds to the fifth quantized network branch 712 in FIG. 7. As shown in FIG. 7(a), the first image quantized network structure includes a third image quantized network branch, a fourth image quantized network branch, a fifth image quantized network branch, and a bmm operator 709. An output of the third image quantized network branch and an output of the fifth image quantized network branch are used as inputs of the bmm operator 709. The third image quantized network branch includes a third quantized convolutional layer 701 and a first reshape operator 702 that have a cascading relationship. The fourth image quantized network branch includes a fourth quantized convolutional layer 703, a third fake-quantization node 704, and a plurality of size operators 705 that have a cascading relationship. The fifth image quantized network branch includes the fourth quantized convolutional layer 703, a fourth fake-quantization node 706, a second reshape operator 707, and a permute operator 708 that have a cascading relationship. The second image quantized network structure is obtained by deleting the third fake-quantization node 704 and the fourth fake-quantization node 706 based on the first image quantized network structure.

Fifth image training data and sixth image training data are obtained. The fifth image training data and the sixth image training data are intermediate feature data obtained based on an image. The fifth image training data is inputted to the third image quantized network branch, to obtain eighth processing data. The sixth training data is inputted to the fourth image quantized convolutional layer, and data outputted by the fourth image quantized convolutional layer is respectively inputted to the plurality of size operators 705, to obtain ninth processing data. The data outputted by the fourth image quantized convolutional layer to the second reshape operator 707, and data outputted by the second reshape operator 707 is inputted to the permute operator 708, to obtain tenth processing data. The eighth processing data and the tenth processing data are inputted to the bmm operator 709, to obtain eleventh processing data. The second image quantized network structure is trained based on an error between the eleventh processing data and a label.

Second type of possible generative model: A partial network structure of the generative model is configured for processing image feature data and text feature data to obtain processed quantized feature data.

In one embodiment, in a case that the image feature data and the text feature data are processed and a second quantized network structure is the first type of second quantized network structure shown in FIG. 3, a first quantized network structure in this embodiment corresponds to the first quantized network structure in FIG. 3, and the second quantized network structure in this embodiment corresponds to the second quantized network structure in FIG. 3. The second quantized network structure is obtained. The second quantized network structure is obtained by inserting or deleting a fake-quantization node based on the first quantized network structure, and the first quantized network structure is a quantized structure of the partial network structure in the generative model. The second quantized network structure is trained. The trained second quantized network structure is determined as a quantization result of the partial network structure.

In some embodiments, the second quantized network structure is obtained based on the first quantized network structure by inserting or deleting a fake-quantization node based on a principle that data precisions of a plurality of pieces of input data of the same target operator are the same.

In one embodiment, in a case that the image feature data is processed, a first image quantized network branch corresponds to the first quantized network branch 313 in FIG. 3. A first text network branch corresponds to the second network branch 312 in FIG. 3. As shown in FIG. 3(b), the first quantized network structure includes a first image quantized network branch, a first text network branch, and an addition operator 306. The first image quantized network branch includes a first convolutional layer 301, a batch normalization layer 302, an activation layer 303, and a second convolutional layer 304 that are quantized and that have a cascading relationship. The first text network branch includes a network layer 305. An output of the first image quantized network branch and an output of the first text network branch are used as inputs of the addition operator 306. The second quantized network structure is obtained by inserting a first fake-quantization node 309 into an output end of the first text network branch and inserting a second fake-quantization node 310 into an output end of the addition operator 306 based on the first quantized network structure.

First image training data and first text training data are obtained. The first image training data is intermediate feature data obtained based on an image, and the first text training data is intermediate feature data obtained based on text. The first image training data is inputted to the first image quantized network branch, to obtain first processing data. The first text training data is inputted to the a network layer 305, and data outputted by the a network layer 305 is inputted to the first fake-quantization node 309, to obtain second processing data. The first processing data and the second processing data are inputted to the addition operator 306, and an addition result is inputted to the second fake-quantization node 310, to obtain third processing data. The second quantized network structure is trained based on an error between the third processing data and a label.

In some embodiments, the first image quantized network branch includes a first quantized convolutional layer 307 and a second quantized convolutional layer 308. The first quantized convolutional layer 307 is obtained by combined quantization based on the first convolutional layer 301, the batch normalization layer 302, and the activation layer 303. The second quantized convolutional layer 308 is obtained by quantizing the second convolutional layer 304.

In one embodiment, in a case that the image feature data and the text feature data are processed and a second quantized network structure is the second type of second quantized network structure shown in FIG. 5, a first quantized network structure in this embodiment corresponds to the first quantized network structure in FIG. 5; the second quantized network structure in this embodiment corresponds to the second quantized network structure in FIG. 5; a second image quantized network branch corresponds to the third quantized network branch 510 in FIG. 5; a second text quantized network branch corresponds to the fourth quantized network branch 511 in FIG. 5; and a third text quantized network branch corresponds to the fifth quantized network branch 512 in FIG. 5. As shown in FIG. 5(a), the first quantized network structure includes a second image quantized network branch, a second text quantized network branch, a third text quantized network branch, and a bmm operator 509. An output of the second image quantized network branch and an output of the third text quantized network branch are used as inputs of the bmm operator 509. The second image quantized network branch includes a third quantized convolutional layer 501 and a first matrix dimension quantity reshape operator 502 that have a cascading relationship. The second text quantized network branch includes a fourth quantized convolutional layer 503, a third fake-quantization node 504, and a plurality of size operators 505 that have a cascading relationship. The third text quantized network branch includes the fourth quantized convolutional layer 503, a fourth fake-quantization node 506, a second reshape operator 507, and a matrix dimension sequence permute operator 508 that have a cascading relationship. The second quantized network structure is obtained by inserting a fifth fake-quantization node 510 into an output end of the third quantized convolutional layer 501 based on the first quantized network structure, as shown in FIG. 5(b).

Second image training data and second text training data are obtained. The second image training data is intermediate feature data obtained based on an image, and the second text training data is intermediate feature data obtained based on text. The second image training data is inputted to the third quantized convolutional layer 501, the fifth fake-quantization node 510, and the first reshape operator 502, to obtain fourth processing data. The second text training data is inputted to the second text quantized network branch, to obtain fifth processing data. The second text training data is inputted to the third text quantized network branch, to obtain sixth processing data. The fourth processing data and the sixth processing data are inputted to the bmm operator 509, to obtain seventh processing data. The second quantized network structure is trained based on an error between the seventh processing data and a label.

In one embodiment, in a case that the image feature data and the text feature data are processed and a second quantized network structure is the third type of second quantized network structure shown in FIG. 7, a first image quantized network structure in this embodiment corresponds to the first quantized network structure in FIG. 7; the second quantized network structure in this embodiment corresponds to the second image quantized network structure in FIG. 7; a second image quantized network branch corresponds to the third quantized network branch 710 in FIG. 7; a second text quantized network branch corresponds to the fourth quantized network branch 711 in FIG. 7; and a third text quantized network branch corresponds to the fifth quantized network branch 712 in FIG. 7. As shown in FIG. 7(a), the first quantized network structure includes a second image quantized network branch, a second text quantized network branch, a third text quantized network branch, and a bmm operator 709. An output of the second image quantized network branch and an output of the third text quantized network branch are used as inputs of the bmm operator 709. The second image quantized network branch includes a third quantized convolutional layer and a first matrix dimension quantity reshape operator 709 that have a cascading relationship. The second text quantized network branch includes a fourth quantized convolutional layer 703, a third fake-quantization node 704, and a plurality of size operators 705 that have a cascading relationship. The third text quantized network branch includes the fourth quantized convolutional layer 703, a fourth fake-quantization node 706, a second reshape operator 707, and a matrix dimension sequence permute operator 708 that have a cascading relationship. The second quantized network structure is obtained by deleting the third fake-quantization node 704 and the fourth fake-quantization node 706 based on the first quantized network structure.

Third image training data and third text training data are obtained. The third image training data is intermediate feature data obtained based on an image, and the third text training data is intermediate feature data obtained based on text. The third image training data is inputted to the second image quantized network branch, to obtain eighth processing data. The third text training data is inputted to the fourth quantized convolutional layer, and data outputted by the fourth quantized convolutional layer is respectively inputted to the plurality of size operators 705, to obtain ninth processing data. The data outputted by the fourth image quantized convolutional layer to the second reshape operator 707, and data outputted by the second reshape operator 707 is inputted to the permute operator 708, to obtain tenth processing data. The eighth processing data and the tenth processing data are inputted to the bmm operator 709, to obtain eleventh processing data. The second quantized network structure is trained based on an error between the eleventh processing data and a label.

Third type of possible generative model: A partial network structure of the generative model is configured for processing text feature data to obtain processed quantized feature data.

In one embodiment, in a case that the text feature data is processed and a second quantized network structure is the first type of second quantized network structure shown in FIG. 3, a first text quantized network structure in this embodiment corresponds to the first quantized network structure in FIG. 3, and a second text quantized network structure in this embodiment corresponds to the second quantized network structure in FIG. 3. The second text quantized network structure is obtained. The second text quantized network structure is obtained by inserting or deleting a fake-quantization node based on the first text quantized network structure, and the first text quantized network structure is a quantized structure of the partial network structure in the generative model. The second text quantized network structure is trained. The trained second text quantized network structure is determined as a quantization result of the partial network structure.

In some embodiments, the second text quantized network structure is obtained based on the first text quantized network structure by inserting or deleting a fake-quantization node based on a principle that data precisions of a plurality of pieces of input data of the same target operator are the same.

In one embodiment, in the case that the text feature data is processed, a first text quantized network branch corresponds to the first quantized network branch 313 in FIG. 3. As shown in FIG. 3(b), the first text quantized network structure includes a first text quantized network branch, a second network branch 312, and an addition operator 306. The first text quantized network branch includes a first convolutional layer 301, a batch normalization layer 302, an activation layer 303, and a second convolutional layer 304 that are quantized and that have a cascading relationship. The second network branch 312 includes a network layer 305. An output of the first text quantized network branch and an output of the second network branch are used as inputs of the addition operator. The second text quantized network structure is obtained by inserting a first fake-quantization node 309 into an output end of the second network branch 312 and inserting a second fake-quantization node 310 into an output end of the addition operator 306 based on the first text quantized network structure.

First text training data and second text training data are obtained. The first text training data and the second text training data are intermediate feature data obtained based on text. The first text training data is inputted to the first text quantized network branch, to obtain first processing data. The second text training data is inputted to the a network layer 305, and data outputted by the a network layer 305 is inputted to the first fake-quantization node 309, to obtain second processing data. The first processing data and the second processing data are inputted to the addition operator 306, and an addition result is inputted to the second fake-quantization node 310, to obtain third processing data. The second text quantized network structure is trained based on an error between the third processing data and a label.

In some embodiments, the first text quantized network branch includes a first quantized convolutional layer 307 and a second quantized convolutional layer 308. The first quantized convolutional layer 307 is obtained by combined quantization based on the first convolutional layer 301, the batch normalization layer 302, and the activation layer 303. The second quantized convolutional layer 308 is obtained by quantization based on the second convolutional layer 304.

In one embodiment, in a case that the text feature data is processed and a second quantized network structure is the second type of second quantized network structure shown in FIG. 5, a first text quantized network structure corresponds to the first quantized network structure in FIG. 5; a second text quantized network structure corresponds to the second quantized network structure in FIG. 5; a third text quantized network branch corresponds to the third quantized network branch 510 in FIG. 5; a fourth text quantized network branch corresponds to the fourth quantized network branch 511 in FIG. 5; and a fifth text quantized network branch corresponds to the fifth quantized network branch 512 in FIG. 5. As shown in FIG. 5(a), the first text quantized network structure includes a third text quantized network branch, a fourth text quantized network branch, a fifth text quantized network branch, and a bmm operator 509. An output of the third text quantized network branch and an output of the fifth text quantized network branch are used as inputs of the bmm operator 509. The third text quantized network branch includes a third quantized convolutional layer 501 and a first matrix dimension quantity reshape operator 502 that have a cascading relationship. The fourth text quantized network branch includes a fourth quantized convolutional layer 503, a third fake-quantization node 504, and a plurality of size operators 505 that have a cascading relationship. The fifth text quantized network branch includes the fourth quantized convolutional layer 503, a fourth fake-quantization node 506, a second reshape operator 507, and a matrix dimension sequence permute operator 508 that have a cascading relationship. The second text quantized network structure is obtained by inserting a fifth fake-quantization node 510 into an output end of the third quantized convolutional layer 501 based on the first quantized network structure, as shown in FIG. 5(b).

Third text training data and fourth text training data are obtained. The third text training data and the fourth text training data are intermediate feature data obtained based on text. The third text training data is inputted to the third quantized convolutional layer 501, the fifth fake-quantization node 510, and the first reshape operator 502, to obtain fourth processing data. The fourth text training data is inputted to the fourth text quantized network branch, to obtain fifth processing data. The fourth text training data is inputted to the fifth text quantized network branch, to obtain sixth processing data. The fourth processing data and the sixth processing data are inputted to the bmm operator 509, to obtain seventh processing data. The second text quantized network structure is trained based on an error between the seventh processing data and a label.

In one embodiment, in a case that the text feature data is processed and a second quantized network structure is the third type of second quantized network structure shown in FIG. 7, a first text quantized network structure corresponds to the first quantized network structure in FIG. 7; a second text quantized network structure corresponds to the second quantized network structure in FIG. 7; a third text quantized network branch corresponds to the third quantized network branch 710 in FIG. 7; a fourth text quantized network branch corresponds to the fourth quantized network branch 711 in FIG. 7; and a fifth text quantized network branch corresponds to the fifth quantized network branch 712 in FIG. 7. As shown in FIG. 7(a), the first text quantized network structure includes a third text quantized network branch, a fourth text quantized network branch, a fifth text quantized network branch, and a bmm operator 709. An output of the third text quantized network branch and an output of the fifth text quantized network branch are used as inputs of the bmm operator 709. The third text quantized network branch includes a third quantized convolutional layer 701 and a first reshape operator 702 that have a cascading relationship. The fourth text quantized network branch includes a fourth quantized convolutional layer 703, a third fake-quantization node 704, and a plurality of size operators 705 that have a cascading relationship. The fifth text quantized network branch includes the fourth quantized convolutional layer 703, a fourth fake-quantization node 706, a second reshape operator 707, and a permute operator 708 that have a cascading relationship. The second text quantized network structure is obtained by deleting the third fake-quantization node 704 and the fourth fake-quantization node 706 based on the first text quantized network structure.

Fifth text training data and sixth text training data are obtained. The fifth text training data and the sixth text training data are intermediate feature data obtained based on text. The fifth text training data is inputted to the third text quantized network branch, to obtain eighth processing data. The sixth text training data is inputted to the fourth quantized convolutional layer, and data outputted by the fourth quantized convolutional layer is respectively inputted to the plurality of size operators 705, to obtain ninth processing data. The data outputted by the fourth quantized convolutional layer to the second reshape operator 707, and data outputted by the second reshape operator 707 is inputted to the permute operator 708, to obtain tenth processing data. The eighth processing data and the tenth processing data are inputted to the bmm operator 709, to obtain eleventh processing data. The second text quantized network structure is trained based on an error between the eleventh processing data and a label.

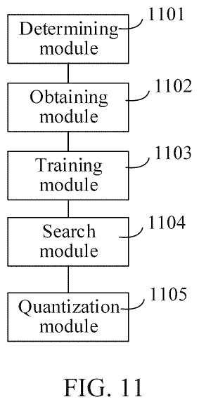

FIG. 11 is a structural block diagram of a model quantization apparatus according to an embodiment of this application. The apparatus includes:

a determining module 1101, configured to perform operation 220 in FIG. 2 above;

an obtaining module 1102, configured to perform operation 240 in FIG. 2 above;

and a training module 1103, configured to perform operation 260 in FIG. 2 above.

In some embodiments, the obtaining module 1102 is further configured to obtain the second quantized network structure, the second quantized network structure being obtained by inserting a first fake-quantization node into an output end of the second network branch and inserting a second fake-quantization node into an output end of the addition operator based on the first quantized network structure.

The training module 1103 is further configured to perform operation 410 to operation 450 in FIG. 4 above.

In some embodiments, the obtaining module 1102 is further configured to obtain the second quantized network structure, the second quantized network structure being obtained by inserting a fifth fake-quantization node into an output end of the third quantized convolutional layer based on the first quantized network structure.

The training module 1103 is further configured to perform operation 610 to operation 650 in FIG. 6 above.

In some embodiments, the obtaining module 1102 is further configured to obtain the second quantized network structure, where the second quantized network structure is obtained by deleting the third fake-quantization node and the fourth fake-quantization node based on the first quantized network structure.

The training module 1103 is further configured to perform operation 810 to operation 850 in FIG. 8 above.

In some other embodiments, the apparatus further includes a search module 1104 and a quantization module 1105. The search module 1104 is configured to perform operation 1001 in FIG. 10 above. The quantization module 1105 is configured to perform operation 1002 in FIG. 10 above.

Here, when the modules in the model quantization apparatus perform the operations in the foregoing figures, an execution sequence is not limited by serial numbers of the operations or a time sequence of the operations.

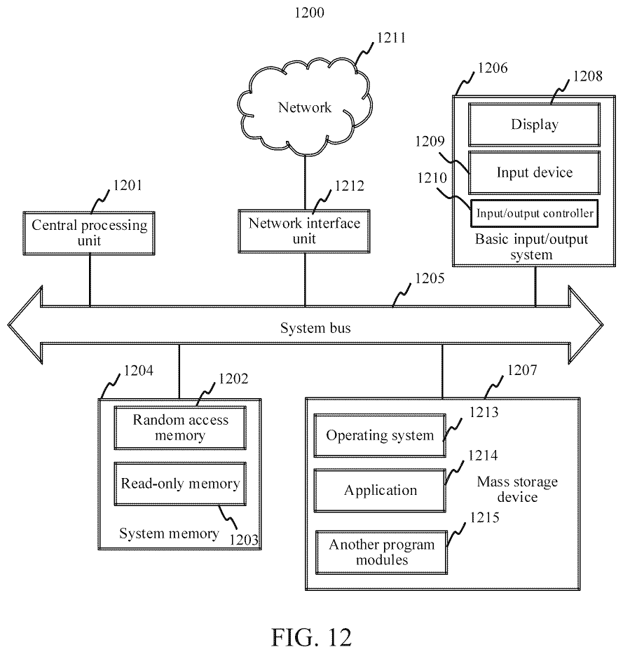

FIG. 12 is a schematic structural diagram of a computer device according to an embodiment. The computer device 1200 includes a central processing unit (CPU) 1201, a system memory 1204 including a random access memory (RAM) 1202 and a read-only memory (ROM) 1203, and a system bus 1205 connecting the system memory 1204 and the central processing unit 1201. The computer device 1200 further includes a basic input/output system (I/O system) 1206 configured to transmit information between components in the computer device, and a mass storage device 1207 configured to store an operating system 1213, an application 1214, and another program module 1215.

The basic I/O system 1206 includes a display 1208 configured to display information and an input device 1209 such as a mouse or a keyboard that is configured for inputting information by a user. The display 1208 and the input device 1209 are both connected to the CPU 1201 through an input/output controller 1210 connected to the system bus 1205. The basic I/O system 1206 may further include the input and output controller 1210 to be configured to receive and process inputs from a plurality of other devices such as a keyboard, a mouse, and an electronic stylus. Similarly, the input/output controller 1210 further provides an output to a display screen, a printer, or another type of output device.

The mass storage device 1207 is connected to the CPU 1201 by using a mass storage controller (not shown) connected to the system bus 1205. The mass storage device 1207 and a computer device-readable medium associated with the mass storage device provide non-volatile storage for the computer device 1200. That is, the mass storage device 1207 may include a computer device-readable medium (not shown) such as a hard disk or a compact disc ROM (CD-ROM) drive.

In general, the computer device-readable medium may include a computer device storage medium and a communication medium. The system memory 1204 and the mass storage device 1207 may be collectively referred to as a memory.

According to the embodiments of this application, the computer device 1200 may further be connected, through a network such as the Internet, to a remote computer device on the network and run. That is, the computer device 1200 may be connected to a network 1211 by using a network interface unit 1212 connected to the system bus 1205, or may be connected to another type of network or a remote computer device system (not shown) by using a network interface unit 1212.

The memory further includes one or more programs. The one or more programs are stored in the memory. The CPU 1201 implements all or some steps of the above model quantization method by performing the one or more programs.

This application further provides a computer-readable storage medium, having at least one instruction, at least one program, a code set, or an instruction set stored therein. The at least one instruction, the at least one program, the code set, or the instruction set is loaded and executed by a processor to implement the model quantization method provided in the foregoing method embodiments.

This application provides a computer program product or a computer program.

The computer program product or computer program includes computer instructions which are stored in a computer-readable storage medium. A processor of a computer device reads the computer instructions from the computer-readable storage medium, and the processor executes the computer instructions, so that the computer device performs the model quantization method in the foregoing method embodiments.

What is claimed is:

1. A model quantization method performed by a model quantization device, and the method comprising:
determining a first quantized network structure from a generative model, the first quantized network structure being a quantized structure of a partial network structure in the generative model, a target operator in the first quantized network structure corresponding to a plurality of pieces of input data having different data precisions;
obtaining a second quantized network structure by inserting or deleting a fake-quantization node based on the first quantized network structure, data precisions of the plurality of pieces of input data of the target operator in the second quantized network structure being the same, and the fake-quantization node being a node for quantizing the input data; and
training the generative model comprising the second quantized network structure.

2. The method according to claim 1, wherein the first quantized network structure comprises at least one of a quantized network branch and a network branch, and an operator;
the obtaining a second quantized network structure comprises at least one of the following operations:
obtaining the second quantized network structure by inserting the fake-quantization node into an output end of the network branch and an output end of the operator based on the first quantized network structure;
obtaining the second quantized network structure by inserting the fake-quantization node into an output end of the quantized network branch based on the first quantized network structure; and
obtaining the second quantized network structure by deleting the fake-quantization node from the quantized network branch based on the first quantized network structure.

3. The method according to claim 2, wherein the first quantized network structure comprises a first quantized network branch, a second network branch, and an addition operator; the first quantized network branch is obtained by quantization based on a first convolutional layer, a batch normalization layer, an activation layer, and a second convolutional layer that have a cascading relationship; the second network branch comprises a network layer; an output of the first quantized network branch and an output of the second network branch are used as inputs of the addition operator; and
the obtaining the second quantized network structure by inserting the fake-quantization node to the network branch and an output end of the operator based on the first quantized network structure comprises:
obtaining the second quantized network structure by inserting a first fake-quantization node into an output end of the second network branch and inserting a second fake-quantization node into an output end of the addition operator based on the first quantized network structure.

4. The method according to claim 3, wherein the training the generative model comprising the second quantized network structure comprises:
obtaining first training data and second training data;
inputting the first training data to the first quantized network branch, to obtain first processing data;
inputting the second training data to the network layer, and inputting data outputted by the network layer to the first fake-quantization node, to obtain second processing data;
inputting the first processing data and the second processing data to the addition operator, and inputting an addition result to the second fake-quantization node, to obtain third processing data; and
training the second quantized network structure based on an error between the third processing data and a label.

5. The method according to claim 3, wherein the first quantized network branch comprises a first quantized convolutional layer and a second quantized convolutional layer; the first quantized convolutional layer is obtained by combined quantization based on the first convolutional layer, the batch normalization layer, and the activation layer; and
the second quantized convolutional layer is obtained by quantization based on the second convolutional layer.

6. The method according to claim 2, wherein the first quantized network structure comprises a third quantized network branch, a fourth quantized network branch, a fifth quantized network branch, and a batch matrix-matrix (bmm) operator; an output of the third quantized network branch and an output of the fifth quantized network branch are used as inputs of the bmm operator; the third quantized network branch comprises a third quantized convolutional layer and a first matrix dimension quantity reshape operator that have a cascading relationship; the fourth quantized network branch comprises a fourth quantized convolutional layer, a third fake-quantization node, and a plurality of size operators that have a cascading relationship; the fifth quantized network branch comprises the fourth quantized convolutional layer, a fourth fake-quantization node, a second reshape operator, and a matrix dimension sequence permute operator that have a cascading relationship; and
the obtaining the second quantized network structure by inserting the fake-quantization node into an output end of the quantized network branch based on the first quantized network structure comprises:
obtaining the second quantized network structure by inserting a fifth fake-quantization node into an output end of the third quantized convolutional layer based on the first quantized network structure.

7. The method according to claim 6, wherein the training the generative model comprising the second quantized network structure comprises:
obtaining third training data and fourth training data;
inputting the third training data to the third quantized convolutional layer, the fifth fake-quantization node, and the first reshape operator, to obtain fourth processing data;
inputting the fourth training data to the fourth quantized network branch, to obtain fifth processing data; inputting the fourth training data to the fifth quantized network branch, to obtain sixth processing data;
inputting the fourth processing data and the sixth processing data to the bmm operator, to obtain seventh processing data; and
training the second quantized network structure based on an error between the seventh processing data and a label.

8. The method according to claim 2, wherein the first quantized network structure comprises a third quantized network branch, a fourth quantized network branch, a fifth quantized network branch, and a bmm operator; an output of the third quantized network branch and an output of the fifth quantized network branch are used as inputs of the bmm operator; the third quantized network branch comprises a third quantized convolutional layer and a first reshape operator that have a cascading relationship; the fourth quantized network branch comprises a fourth quantized convolutional layer, a third fake-quantization node, and a plurality of size operators that have a cascading relationship; the fifth quantized network branch comprises the fourth quantized convolutional layer, a fourth fake-quantization node, a second reshape operator, and a permute operator that have a cascading relationship; and
the obtaining the second quantized network structure by deleting the fake-quantization node from the quantized network branch based on the first quantized network structure comprises:
obtaining the second quantized network structure by deleting the third fake-quantization node and the fourth fake-quantization node based on the first quantized network structure.

9. The method according to claim 8, wherein the training the generative model comprising the second quantized network structure comprises:
obtaining fifth training data and sixth training data;
inputting the fifth training data to the third quantized network branch, to obtain eighth processing data;
inputting the sixth training data to the fourth quantized convolutional layer, and respectively inputting data outputted by the fourth quantized convolutional layer to the plurality of size operators, to obtain ninth processing data; inputting the data outputted by the fourth quantized convolutional layer to the second reshape operator, and inputting data outputted by the second reshape operator to the permute operator, to obtain tenth processing data;
inputting the eighth processing data and the tenth processing data to the bmm operator, to obtain eleventh processing data; and
training the second quantized network structure based on an error between the eleventh processing data and a label.

10. The method according to claim 1, further comprising:
searching for a network structure in the generative model; and
quantizing a target network structure in a case that the network structure in the generative model comprises the target network structure, the quantized target network structure being the first quantized network structure or a part of the first quantized network structure.

11. A computer device, comprising: one or more processors and one or more memory, the memory having a computer program stored therein, and the computer program being loaded and executed by the one or more processors to implement a model quantization method performed by a model quantization device, and the method comprising:
determining a first quantized network structure from a generative model, the first quantized network structure being a quantized structure of a partial network structure in the generative model, a target operator in the first quantized network structure corresponding to a plurality of pieces of input data having different data precisions;
obtaining a second quantized network structure by inserting or deleting a fake-quantization node based on the first quantized network structure, data precisions of the plurality of pieces of input data of the target operator in the second quantized network structure being the same, and the fake-quantization node being a node for quantizing the input data; and
training the generative model comprising the second quantized network structure.

12. The computer device according to claim 11, wherein the first quantized network structure comprises at least one of a quantized network branch and a network branch, and an operator;
the obtaining a second quantized network structure comprises at least one of the following operations:
obtaining the second quantized network structure by inserting the fake-quantization node into an output end of the network branch and an output end of the operator based on the first quantized network structure;
obtaining the second quantized network structure by inserting the fake-quantization node into an output end of the quantized network branch based on the first quantized network structure; and
obtaining the second quantized network structure by deleting the fake-quantization node from the quantized network branch based on the first quantized network structure.

13. The computer device according to claim 12, wherein the first quantized network structure comprises a first quantized network branch, a second network branch, and an addition operator; the first quantized network branch is obtained by quantization based on a first convolutional layer, a batch normalization layer, an activation layer, and a second convolutional layer that have a cascading relationship; the second network branch comprises a network layer; an output of the first quantized network branch and an output of the second network branch are used as inputs of the addition operator; and
the obtaining the second quantized network structure by inserting the fake-quantization node to the network branch and an output end of the operator based on the first quantized network structure comprises:
obtaining the second quantized network structure by inserting a first fake-quantization node into an output end of the second network branch and inserting a second fake-quantization node into an output end of the addition operator based on the first quantized network structure.

14. The computer device according to claim 13, wherein the training the generative model comprising the second quantized network structure comprises:
obtaining first training data and second training data;
inputting the first training data to the first quantized network branch, to obtain first processing data;
inputting the second training data to the network layer, and inputting data outputted by the network layer to the first fake-quantization node, to obtain second processing data;
inputting the first processing data and the second processing data to the addition operator, and inputting an addition result to the second fake-quantization node, to obtain third processing data; and
training the second quantized network structure based on an error between the third processing data and a label.

15. The computer device according to claim 13, wherein the first quantized network branch comprises a first quantized convolutional layer and a second quantized convolutional layer; the first quantized convolutional layer is obtained by combined quantization based on the first convolutional layer, the batch normalization layer, and the activation layer; and
the second quantized convolutional layer is obtained by quantization based on the second convolutional layer.

16. The computer device according to claim 12, wherein the first quantized network structure comprises a third quantized network branch, a fourth quantized network branch, a fifth quantized network branch, and a batch matrix-matrix (bmm) operator; an output of the third quantized network branch and an output of the fifth quantized network branch are used as inputs of the bmm operator; the third quantized network branch comprises a third quantized convolutional layer and a first matrix dimension quantity reshape operator that have a cascading relationship; the fourth quantized network branch comprises a fourth quantized convolutional layer, a third fake-quantization node, and a plurality of size operators that have a cascading relationship; the fifth quantized network branch comprises the fourth quantized convolutional layer, a fourth fake-quantization node, a second reshape operator, and a matrix dimension sequence permute operator that have a cascading relationship; and
the obtaining the second quantized network structure by inserting the fake-quantization node into an output end of the quantized network branch based on the first quantized network structure comprises:
obtaining the second quantized network structure by inserting a fifth fake-quantization node into an output end of the third quantized convolutional layer based on the first quantized network structure.

17. The computer device according to claim 16, wherein the training the generative model comprising the second quantized network structure comprises:
obtaining third training data and fourth training data;
inputting the third training data to the third quantized convolutional layer, the fifth fake-quantization node, and the first reshape operator, to obtain fourth processing data;
inputting the fourth training data to the fourth quantized network branch, to obtain fifth processing data; inputting the fourth training data to the fifth quantized network branch, to obtain sixth processing data;
inputting the fourth processing data and the sixth processing data to the bmm operator, to obtain seventh processing data; and
training the second quantized network structure based on an error between the seventh processing data and a label.

18. The computer device according to claim 12, wherein the first quantized network structure comprises a third quantized network branch, a fourth quantized network branch, a fifth quantized network branch, and a bmm operator; an output of the third quantized network branch and an output of the fifth quantized network branch are used as inputs of the bmm operator; the third quantized network branch comprises a third quantized convolutional layer and a first reshape operator that have a cascading relationship; the fourth quantized network branch comprises a fourth quantized convolutional layer, a third fake-quantization node, and a plurality of size operators that have a cascading relationship; the fifth quantized network branch comprises the fourth quantized convolutional layer, a fourth fake-quantization node, a second reshape operator, and a permute operator that have a cascading relationship; and
the obtaining the second quantized network structure by deleting the fake-quantization node from the quantized network branch based on the first quantized network structure comprises:
obtaining the second quantized network structure by deleting the third fake-quantization node and the fourth fake-quantization node based on the first quantized network structure.

19. The computer device according to claim 18, wherein the training the generative model comprising the second quantized network structure comprises:
obtaining fifth training data and sixth training data;
inputting the fifth training data to the third quantized network branch, to obtain eighth processing data;
inputting the sixth training data to the fourth quantized convolutional layer, and respectively inputting data outputted by the fourth quantized convolutional layer to the plurality of size operators, to obtain ninth processing data; inputting the data outputted by the fourth quantized convolutional layer to the second reshape operator, and inputting data outputted by the second reshape operator to the permute operator, to obtain tenth processing data;
inputting the eighth processing data and the tenth processing data to the bmm operator, to obtain eleventh processing data; and
training the second quantized network structure based on an error between the eleventh processing data and a label.

20. A non-transitory computer-readable storage medium, having a computer program stored therein, the computer program being loaded and executed by a processor to implement a model quantization method performed by a model quantization device, and the method comprising:
determining a first quantized network structure from a generative model, the first quantized network structure being a quantized structure of a partial network structure in the generative model, a target operator in the first quantized network structure corresponding to a plurality of pieces of input data having different data precisions;
obtaining a second quantized network structure by inserting or deleting a fake-quantization node based on the first quantized network structure, data precisions of the plurality of pieces of input data of the target operator in the second quantized network structure being the same, and the fake-quantization node being a node for quantizing the input data; and
training the generative model comprising the second quantized network structure.
